(19) United States
(12) Patent Application Publication
(10) Pub. No.: US 2018/0347501 A1
(43) Pub. Date: Dec. 6, 2018

(54) Method for Operating an Internal Combustion Engine, in Particular of a Motor Vehicle

(71) Applicant: Daimler AG, Stuttgart (DE)

(72) Inventors: Nils LAUDENBACH, Stuttgart (DE); Markus FENZL, Forchtenberg (DE)

(73) Assignee: Daimler AG, Stuttgart (DE)

(21) Appl. No.: 15/778,197

(22) PCT Filed: Nov. 15, 2016
(86) PCT No.: PCT/EP2016/001906

§ 371 Date: May 22, 2018

(30) Foreign Application Priority Data
Nov. 28, 2015 (DE) 102015015362.5

(51) Int. Cl. F02D 41/40; F02M 45/02; F02D 41/04

(52) U.S. Cl. CPC F02D 41/402; F02D 2041/389; F02D 41/047; F02M 45/02

(57) ABSTRACT

A method for operating an internal combustion engine, which has at least one combustion chamber, at least one intake valve associated with the combustion chamber, and at least one injector associated with the combustion chamber, includes injecting fuel directly into the combustion chamber by the injector in order to operate the internal combustion chamber, where at least one partial stroke of the injector is performed while the intake valve is open.

The invention relates to a method for operating an internal combustion engine, in particular of a motor vehicle, according to the preamble of claim 1.

A method of this kind for operating an internal combustion engine, in particular of a motor vehicle, has long been known from the general prior art and particularly from the field of series vehicle manufacturing. In this case, the internal combustion engine comprises at least one combustion chamber. The internal combustion engine is designed as a reciprocating internal combustion engine, for example, and therefore the combustion chamber is designed as a cylinder, for example.

The internal combustion engine also comprises at least one intake valve associated with the combustion chamber. Usually, two intake valves are associated with the combustion chamber. An intake valve of this kind is a gas exchange valve, which can be moved between a closed position and at least one open position, in particular a plurality of open positions. The intake valve controls the gas exchange. The intake valve is used to control, i.e. to set, an inflow of at least air into the combustion chamber. For example, at least one intake duct is associated with the intake valve, through which duct at least air can flow. If the intake valve is in the closed position, the intake duct is fluidically shut off, and therefore air cannot flow through the intake duct and from the intake duct into the combustion chamber. If the intake valve is open, at least air can flow through the intake duct and from the intake duct into the combustion chamber.

In addition, at least one injector is associated with the combustion chamber. Within the context of the method, fuel, in particular liquid fuel, is injected directly into the combustion chamber by means of the injector in order to operate the internal combustion engine. A fuel direct injection process is thus provided, which is also referred to as direct injection, the fuel being injected directly into the combustion chamber by means of the injector within the context of the direct injection.

Injecting fuel into the combustion chamber and supplying air to the combustion chamber produces a fuel-air mixture in the combustion chamber, which mixture can be ignited and burned, for example by means of an ignition device. This results in exhaust gas in the combustion chamber of the internal combustion engine.

Moreover, DE 102 31 582 A1 discloses a method for forming an ignitable fuel-air mixture in a combustion chamber of a direct injection internal combustion engine, in particular an external-ignition internal combustion engine, which comprises a fuel injection nozzle that has a sealing body. The fuel injection nozzle is part of an injector. In this method, the sealing body of the fuel injection nozzle is moved from a closed position to an operating position by means of a control device, it being possible for an operating stroke and a fuel injection duration to be variably set. In this case, during a fuel injection process the sealing body is moved between the closed position and the operating position at a varying acceleration such that different speeds are set until the predeterminable operating stroke is set.

The object of the present invention is to develop a method of the type mentioned at the outset such that it is possible to achieve operation of the internal combustion engine that is particularly favorable in terms of consumption and emissions.

This object is achieved by a method having the features of claim 1. Advantageous embodiments of the invention comprising expedient developments are specified in the remaining claims.

In order to develop a method of the type specified in the preamble of claim 1, such that it is possible to achieve operation of the internal combustion engine that is particularly favorable in terms of consumption and emissions, according to the invention the fuel is injected, in particular directly injected, into the combustion chamber by means of the injector, by at least one partial stroke of the injector being performed, while the intake valve is open. It is therefore preferable for the partial stroke to be performed in full while the intake valve is opened. The partial stroke of the injector is described in the following: The injector comprises a fuel injection nozzle, in which the fuel or a portion of the fuel can be received. In this case the fuel injection nozzle comprises at least one outlet opening, which is referred to as an injection opening, exit opening or injection hole and is designed as a through-opening. In the process, the fuel injection nozzle defines at least one receiving chamber for receiving the fuel in the injector. One side of the injection opening is fluidically connected to the receiving chamber, and the other side opens into the surroundings of the injector. When the internal combustion engine is in a finished manufactured state, the injection opening thus opens into the combustion chamber, and therefore at least one portion of the fuel that is received in the receiving chamber of the injector can be completely injected, via the injection opening, out of the receiving chamber or out of the injector and thus injected directly into the combustion chamber.

In this case, the injector comprises at least one valve element which is movable, in particular in translation, relative to the fuel injection nozzle. Furthermore, the valve element is received in the fuel injection nozzle or injector at least in part, the valve element being designed as a pin or valve pin. The valve element can be moved between a closed position and at least two open positions which are different from the closed position and different from one another. When in the closed position, the valve element abuts a valve seat in the fuel injection nozzle and separates the injection openings from the receiving chamber. When in the open position, the valve element is lifted off the valve seat thereof, and the injection openings and receiving chamber are fluidically connected.

If the injector is designed as an outwardly opening injector that comprises an outwardly opening fuel injection nozzle, the valve element therefore moves, on its way from the closed position into the corresponding open position, away from the fuel injection nozzle or from the valve seat and into the combustion chamber. If the injector is designed as an inwardly opening injector that comprises an inwardly opening fuel injection nozzle, the valve element therefore moves, on its way from the closed position into the corresponding open position, from the valve seat into the fuel injection nozzle or away from the combustion chamber.

The injector has a flow cross-section through which the fuel received in the injector can be injected out of the receiving chamber or out of the injector and can thus be injected directly into the combustion chamber. In the outwardly opening fuel injection nozzle, this flow cross-section is formed by the injection opening and, in the inwardly opening fuel injection nozzle, said flow cross-section is formed by the injection openings and a cross-section between the valve element and the valve seat thereof, as a whole. In the closed position, the injection opening or injection openings or the flow cross-section can be fluidically shut off by means of the valve element, and therefore fuel is not injected out of the injector and into the combustion chamber. The closed position is in this case a first end position of the valve element.

A first of the open positions is a second end position of the valve element, it being possible to move the valve element at most between the first end position and the second end position. In other words, the valve element can be moved at most within an adjustment range, the adjustment range being delimited by the end positions. If the valve element moves out of the closed position into the first open position and then again out of the first open position back into the closed position, the valve element or the injector thus performs the full stroke thereof or a full stroke of the valve element is caused. In the first open position, the valve element releases at least a first portion of the flow cross-section, and therefore fuel can be injected out of the injector through the first released portion and thus can be directly injected into the combustion chamber. In the first position, the valve element fully releases the flow cross-section.

The adjustment range includes the second open position which is arranged, based on the adjustment range, between the two end positions. If the valve element is moved out of the closed position into the second open position and then again out of the second open position back into the closed position, a movement of the valve element out of the second open position into the first open position being prevented, the valve element or the injector as a whole performs the partial stroke thereof or a partial stroke of the valve element and thus the injector as a whole is caused or performed. In the second open position, the valve element releases a flow cross-section that is smaller than the full stroke.

This means that the full stroke of the valve element or the injector is caused by the valve element being moved out of the closed position into the first open position and then again out of the first open position back into the closed position. Furthermore, the partial stroke of the valve element and thus of the injector is caused by the valve element being moved out of the closed position into the second open position and then again out of the second open position back into the closed position, without the valve element being moved out of the second position and further towards the first open position or into the first open position. Within the context of the partial stroke, the valve element is thus not moved into the second end position.

A timespan, during which the valve element is moved out of the closed position into the corresponding open position and then again out of the corresponding open position back into the closed position, is also referred to as the opening time, injection time or injection duration, since the valve element or the injector as a whole is open during the injection time, and therefore fuel, in particular liquid fuel, is injected directly into the combustion chamber by means of the injector during the injection time. Since, as described, the released second portion is smaller than the released first portion, a larger amount of fuel is injected into the combustion chamber, while maintaining the same fuel pressure and the same injection time, by means of the full stroke than when using the partial stroke.

The amount of fuel injected by means of the injector is also referred to as the injection amount. According to the invention, the fuel is directly injected into the combustion chamber by the partial stroke, rather than the full stroke, of the injector being performed while the intake valve is open.

Two intake valves may be associated with the combustion chamber that is designed as a cylinder, the fuel preferably being injected into the combustion chamber by the at least one partial stroke of the injector being performed while the intake valve or all of the intake valves associated with the combustion chamber is/are open.

An intake duct is associated with the corresponding intake valve, via which intake duct at least air can be supplied to the combustion chamber. This means that at least air can flow through the intake duct. The intake valve can be moved, in particular in translation, between a closed position and at least one open position. When the intake valve is in the closed position, the intake duct associated with the intake valve is fluidically shut off by means of the intake valve, and therefore air cannot flow through the intake duct. Air consequently cannot flow from the intake duct into the combustion chamber when the intake valve is in the closed position thereof. When the intake valve is in the open position, the intake valve releases the intake duct associated with the intake valve, and therefore air can flow through the intake duct and from the intake duct into the combustion chamber. The intake valve is therefore a gas exchange valve for controlling the gas exchange of the combustion chamber. In this case, the intake valve is held on a cylinder head of the internal combustion engine so as to be movable and can thus be moved, in particular in translation, relative to the cylinder head between the closed position and the open position.

The combustion chamber is delimited at least in part, in particular laterally, by what is referred to as a combustion chamber wall or cylinder wall, the combustion chamber wall being formed by a housing element, in particular a cylinder housing, of the internal combustion engine or by a liner. Furthermore, a piston is received in the combustion chamber so as to be movable, in particular movable in translation. The translationally movable piston can be moved between a bottom dead center and a top dead center.

Moreover, the combustion chamber is delimited, in a direction in which the piston moves on its way to the top dead center, by a combustion chamber roof, it being possible for the combustion chamber roof to be formed by the aforementioned cylinder head.

The method according to the invention makes it possible for the raw emissions in particular, and thereby especially the soot particle emissions, from the internal combustion engine to be kept particularly low, and to be reduced by comparison with conventional methods. In this case the invention is based on the finding that soot particles are produced in particular by the wetting of pistons, combustion chamber wall, combustion chamber roof and intake valves with fuel. Since, for example in homogeneous or homogeneous lean combustion methods, and in HOS (homogeneous stratified) and HSP (homogeneous split) operating modes, the intake valves are open while fuel is injected during an intake stroke of the internal combustion engine, this leads in particular to the intake valve, in particular the surfaces of the intake valve that face the associated intake duct, being wetted with fuel. The fuel is injected into the combustion chamber by forming what is referred to as a spray. In the process, the fuel is reflected from the combustion chamber roof and combustion chamber wall by the high momentum of the spray from the open intake valve. The method according to the invention makes it possible to keep the wetting or reflection low, which therefore results in a demonstrably lower particle emission, i.e. soot particle emission, and improved fuel preparation in the combustion chamber results in lower fuel consumption.

The method according to the invention can be carried out within the context of normal operation of the internal combustion engine, the internal combustion engine, which is also referred to as the engine or combustion engine, being hot within the context of normal operation and thereby having an advantageous operating temperature. The particle emissions and the fuel consumption in normal operation can thus be kept particularly low by means of the method according to the invention.

It has also been found to be particularly advantageous for the method according to the invention to be carried out during a warm-up period, in particular during a warm-up period that temporally precedes normal operation, for heating up the internal combustion engine. During the warm-up period, the internal combustion engine has a lower temperature than during normal operation. Within the context of the warm-up period, for example at least one exhaust gas post-treatment means, which is arranged in an exhaust channel through which exhaust gas from the internal combustion engine can flow, is heated and thus brought to the advantageous operating temperature thereof. This heating of the exhaust gas post-treatment means is also referred to as “cat heating”, since the exhaust gas post-treatment means comprises, for example, at least one catalytic converter, in particular an oxidizing catalytic converter. It has been found that the exhaust gas emissions, in particular during cat heating and during the warm-up period, present large challenges with regard to achieving lower emissions.

Usually, i.e. in conventional internal combustion engines, during cat heating and during the warm-up period the exhaust gas emissions are normally affected by mostly compromised designs of injection timing or injection time, spray properties, or the geometry of the combustion chamber, piston and channels. Often, the properties that are optimized for these operating states are not, however, the optimum for other operating states. By using the method according to the invention, a compromised design of the internal combustion engine of this kind is not provided and not required.

The injector is preferably designed as an outwardly opening piezo injector, the flexible properties of which, in particular by comparison with a magnetic injector that has an inwardly opening multi-hole valve, can be used to carry out the method according to the invention and in the process to perform in particular the partial stroke and not the full stroke while the intake valve is open.

The invention is therefore based in particular on the concept of causing fuel injections, which, for reasons of operation strategy, are performed while the intake valve is opened, by means of partial stroke injections, i.e. by performing the partial stroke of the injector, in particular when the engine is cold. Surprisingly, it has been found that the properties of the spray can be affected by the partial stroke being performed, and therefore the properties of the spray positively change in respect of wetting the intake valve with fuel or in respect of the aforementioned reflection. A particularly small fuel droplet size can be achieved by using the partial stroke. The droplet size, which is small or is reduced by comparison with conventional internal combustion engines as a result of the partial stroke, allows the in particular liquid fuel to evaporate very well even in cold engine conditions. What is referred to as the spray penetration decreases, the spray momentum is reduced, and therefore reflections from the intake valve are reduced, and the fuel mass is distributed over a particularly large crank angle range, since the static flow, which is reduced in the partial stroke, is compensated by a longer opening duration or injection duration.

It is conceivable for the injected amount of fuel, in the form of a partial amount, to impinge upon the intake valve over a particularly large timeframe at a low momentum, and therefore a reflection of the liquid lamellae on the intake valve can be prevented, as a result of which a decrease in particle emissions is achieved. Since, as previously described, a smaller amount of fuel is injected by means of the partial stroke than by means of the full stroke while maintaining the same injection time and the same fuel pressure, a longer injection time is provided, for example, when performing the partial stroke than when performing the full stroke, in order to be able to inject a sufficiently large fuel amount into the combustion chamber. It is also conceivable that, by means of the spray of fuel that can be caused by the partial stroke and is finer by comparison with the full stroke, this fuel is distributed over a particularly large portion of the intake valve, which therefore facilitates evaporation the liquid fuel from the intake valve. If it is inherently not possible to completely prevent wetting of the intake valve with fuel, the effects of this wetting can at least be kept low by means of the method according to the invention. As a result, an operation of the internal combustion engine that is particularly favorable in terms of consumption and emissions can be achieved.

A further embodiment is characterized in that the fuel is injected into the combustion chamber by at least one portion of a further stroke of the injector being performed while the injector is open. As a result of this, a sufficient amount of fuel can be injected into the combustion chamber, it being possible, at the same time, to keep the emissions of the internal combustion engine particularly low.

It has been found to be particularly advantageous if a further partial stroke of the injector is performed as the further stroke. In this case, the momentum of the spray and the resulting undesired effects can be kept particularly low, and therefore an operation that is particularly favorable in terms of consumption and emissions can be achieved.

In order to be able to inject a sufficiently large amount of fuel into the combustion chamber while simultaneously achieving an operation that is favorable in terms of consumption and emissions, in a further embodiment of the invention the number of strokes of the injector that are performed within precisely one intake stroke of the internal combustion engine is within a range of 2 to 8 inclusive, one of these strokes being the at least one partial stroke, and fuel being directly injected into the combustion chamber in each case by means of the strokes.

In this case it has been found to be advantageous when each of the strokes is performed as a partial stroke of the injector, and therefore the emissions and fuel consumption can be kept particularly low.

Moreover, it has been found to be advantageous if at least one of the strokes is performed as the full stroke of the injector in order to thus be able to inject a sufficient amount of fuel into the combustion chamber.

Moreover, it has been found in this case to be advantageous if at least one of the strokes is performed in full while the intake valve is closed.

A further embodiment is characterized in that at least two of the strokes differ from one another with regard to the respective injection times thereof. When performing the at least one partial stroke, a long injection time is set in order to introduce a sufficient amount of fuel into the combustion chamber, despite performing the partial stroke, but to introduce said fuel only at an advantageous low momentum. A lower injection time can be set when performing the full stroke by comparison with performing the partial stroke, and therefore a sufficiently large amount of the fuel can be injected into the combustion chamber in a short time.

The invention also relates to an internal combustion engine, in particular for a motor vehicle such as, for example, a passenger car, the internal combustion engine being designed to carry out a method according to the invention. Advantageous embodiments of the method according to the invention should be considered advantageous embodiments of the internal combustion engine according to the invention, and vice versa.

Further advantages, features and details of the invention are found in the following description of preferred embodiments and with reference to the drawings. The features and combinations of features stated above in the description as well as the features and combinations of features stated below in the description of the figures and/or shown in the figures alone can be used not only in the combination specified in each case, but also in other combinations or in isolation without departing from the scope of the invention.

In the drawings:

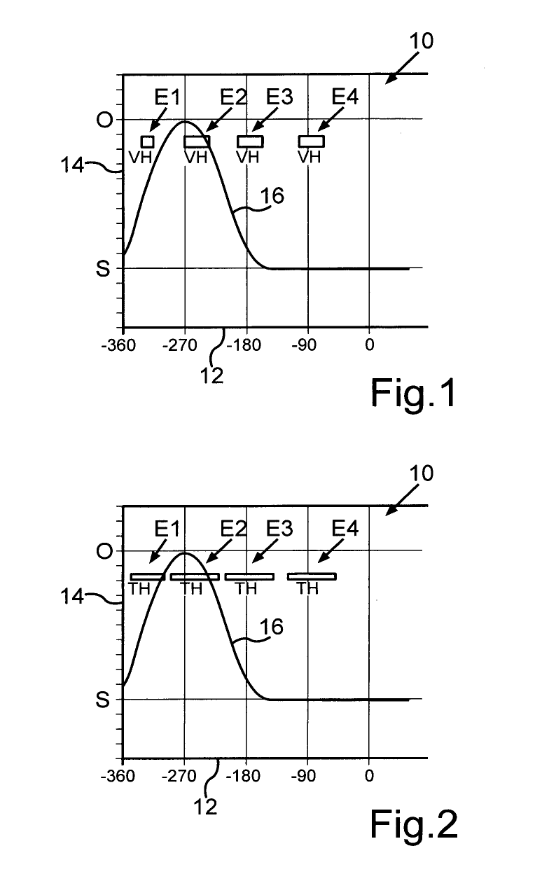

FIG. 1 is a graph to illustrate a method for operating an internal combustion engine, FIG. 1 being used to explain the background of the invention;

FIG. 2 is a graph to illustrate a method according to a first embodiment for operating an internal combustion engine comprising at least one combustion chamber, at least one intake valve associated with the combustion chamber, and at least one injector associated with the combustion chamber, in which method fuel is injected directly into the combustion chamber by means of the injector in order to operate the internal combustion chamber, the fuel being injected into the combustion chamber by at least one partial stroke of the injector being performed while the intake valve is open;

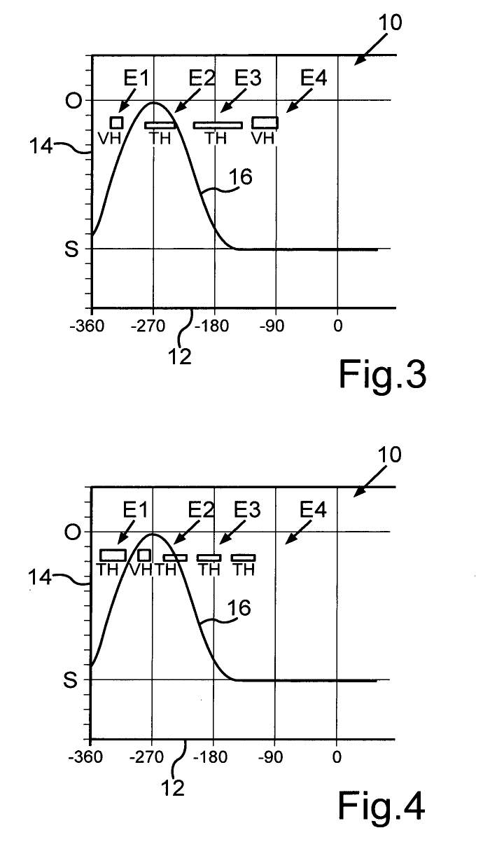

FIG. 3 is a graph to illustrate the method according to a second embodiment; and

FIG. 4 is a graph to illustrate the method according to a third embodiment.

Identical or functionally identical elements are provided with the same reference signs in the figures.

FIG. 1 shows a graph 10, on the basis of which a method for operating an internal combustion engine is described. The internal combustion engine is, for example, a component of a motor vehicle which can be driven by means of the internal combustion engine. The internal combustion engine is, for example, designed as a reciprocating internal combustion engine and comprises at least one combustion chamber which is, for example, designed as a cylinder. The cylinder is, for example, formed or delimited at least in part by a first housing element in the form of a cylinder housing of the internal combustion engine. In this case, the cylinder housing forms for example a cylinder wall, by means of which the cylinder is delimited, in particular laterally or in the radial direction.

The internal combustion engine comprises an output shaft in the form of a crankshaft. The internal combustion engine also comprises a second housing element in the form of a crankcase, it being possible for the second housing element to be integral with the first housing element. Alternatively, it is conceivable for the second housing element to be designed as a component that is formed separately from the first housing element and is connected to the first housing element. The crankshaft is mounted on the crankcase (second housing element) so as to be rotatable about a rotational axis relative to the crankcase. The crankshaft can thus be rotated into different rotational positions about the rotational axis, the rotational positions also being referred to as the crank angle or degree of crank angle. In this case the graph 10 shows an x-axis 12, on which the corresponding crank angle is plotted in degrees.

A piston is received in the cylinder so as to be translationally movable. The piston is hingedly coupled to the crankshaft by a connecting rod, and therefore the translational movements of the piston are converted into a rotary movement of the crankshaft about the rotational axis thereof relative to the crankcase.

At least one intake valve is associated with the cylinder. This intake valve is a gas exchange valve which can be moved, in particular in translation, between a closed position and at least one open position. Moreover, at least one injection valve is associated with the cylinder, which injection valve is also referred to as an injector. Fuel, in particular liquid fuel, can be injected directly into the cylinder by means of the injector in order to operate the internal combustion engine.

The internal combustion engine comprises a third housing element which is designed as a cylinder head. The cylinder head is formed separately from the first housing element and is connected to the first housing element. The piston can be moved in the cylinder between a bottom dead center and a top dead center. The cylinder is delimited, in a direction in which the piston moves on its way to the top dead center, by a combustion chamber roof which is formed by the cylinder head. The intake valve is in this case held on the cylinder head so as to be translationally movable.

For example, at least one camshaft is provided which is mounted on the cylinder head so as to be rotatable about a rotational axis relative to the cylinder head, for example, and which can be driven by the crankshaft, via a drive system. The intake valve can be moved out of the closed position thereof into the open position thereof by means of the camshaft. This means that the intake valve can be actuated by means of the camshaft. At least one spring is associated with the intake valve, one side of which spring is supported at least indirectly on the cylinder head and the other side of which spring is supported at least indirectly on the intake valve. The spring is tensioned by moving the intake valve out of the closed position into the open position, and therefore the spring provides a spring force which acts on the intake valve that is in the open position. The intake valve is moved out of the closed position into the open position by means of the camshaft and is held in the open position at least temporarily. The intake valve is kept in contact with the camshaft by means of the spring force. The intake valve is also moved out of the open position back into the closed position by means of the spring force.

At least one intake duct is associated with the intake valve, which intake duct is formed by the cylinder head. As will be described in greater detail in the following, the intake valve is used to control the gas exchange of the cylinder. In particular, the intake valve is used to control, i.e. to set, an inflow of at least air into the cylinder. In the closed position, the intake duct is fluidically shut off by means of the intake valve, and therefore air cannot flow through the intake duct and from the intake duct into the cylinder. In the open position, the intake valve releases the intake duct, and therefore air can flow through the intake duct and from the intake duct into the cylinder.

Analogously to the intake valve, a further gas exchange valve in the form of an outlet valve is associated with the cylinder. The outlet valve is used to control, i.e. set, an outflow of exhaust gas out of the cylinder. In the closed position, an outlet duct associated with the outlet valve is fluidically shut off by means of the outlet valve, and therefore exhaust gas from a burned air-fuel mixture cannot flow through the outlet duct and from the outlet duct out of the cylinder. In the open position, the outlet valve releases the outlet duct, and therefore exhaust gas can flow through the outlet duct and from the outlet duct out of the cylinder.

The injector comprises a fuel injection nozzle which defines at least one receiving chamber for receiving the fuel. The injector, in particular the fuel injection nozzle, also has a flow cross-section through which at least one portion of the fuel received in the receiving chamber can be injected out of the injector, in particular the fuel injection nozzle, and can be injected directly into the combustion chamber. This flow cross-section is formed by precisely one injection opening or by a plurality of injection openings in the injector, in particular of the fuel injection nozzle. The relevant injection opening is also referred to as an outlet opening, exit opening, ejection opening, injection hole or through-hole. One side of the relevant injection opening is fluidically connected to the receiving chamber, and therefore fuel can flow out of the receiving chamber through the injection opening. The other side of said injection opening opens into the surroundings and thus, when the internal combustion engine is in a finished manufactured state, opens directly into the combustion chamber, and therefore the fuel received in the receiving chamber can be injected directly into the combustion chamber through the injection opening.

The injector also comprises a valve element, which is designed as a pin or valve pin. The valve element is received at least in part, in particular at least mostly, in the fuel injection nozzle. In addition, the valve element can be moved, in particular in translation, relative to the fuel injection nozzle. In the process, the valve element can be moved, relative to the fuel injection nozzle, between a dosed position and at least two open positions which are different from one another and from the closed position. In the closed position, the flow cross-section is fluidically shut off by means of the valve element, and therefore fuel cannot be injected into the combustion chamber by means of the injector. In a first of the open positions, the valve element releases at least a first portion of the flow cross-section, and therefore fuel is injected out of the receiving chamber of the injector, through the first released portion, and into the combustion chamber. In particular, the valve element fully releases the injection surface in the first open position.

The closed position is therefore a first end position of the valve element, the first open position being a second end position of the valve element. The valve element can be moved into the end positions and between the end positions, but the valve element cannot be moved beyond the relevant end position. The valve element can thus be moved relative to the housing within a movement range, the movement range being delimited by the end positions, and the movement range including the end positions.

The second open position is, based on the movement range, an intermediate position of the valve element, the intermediate position, based on the movement range, being between the end positions. In the second open position, the valve element releases a second portion of the flow cross-section which is smaller by comparison with the first portion, and therefore fuel can be injected out of the injector and directly injected into the combustion chamber, via the second released portion. Since the second open position is between the end positions, the valve element or the injector as a whole opens further in the first open position than in the second open position. However, the valve element or the injector is open in both open positions, since the corresponding portion of the flow cross-section is released.

A full stroke, denoted VH in the figures, of the valve element and thus of the injector as a whole is caused or performed when the valve element is moved out of the closed position into the first open position and then again out of the first open position back into the closed position. A partial stroke, denoted TH in the figures, of the valve element or the injector as a whole is performed or caused when the valve element is moved out of the closed position into the second open position and then again out of the second open position back into the closed position, the valve element that has moved into the second open position being prevented from moving out of the second open position into the first open position. In other words, when performing a partial stroke TH, the valve element moves out of the closed position merely into the second open position, but not beyond the second open position or at least not out of the second open position into the first open position, but instead the valve element is moved back into the closed position after reaching the second open position, without the valve element moving out of the second open position and further towards the first open position. This means that, when performing the partial stroke, although the valve element is open, i.e. is moved out of the closed position, the valve element is not moved into the first open position, and therefore the valve element does not reach the first open position when moving out of the closed position and back into the closed position again within the context of the partial stroke.

A timespan during which the valve element or the injector as a whole is open is also referred to as an opening time, injection duration or injection time. During this injection time, the valve element is not in the closed position, and therefore fuel is injected into the combustion chamber by means of the injector during the injection time.

Overall it can be seen that the valve element performs a stroke when moving out of the closed position into the relevant open position, it being possible for the described full stroke and the described partial stroke of the valve element to be performed or caused.

The intake valve also performs a stroke, also referred to as a valve stroke, when moving out of the closed position into the open position of the intake valve. This valve stroke is plotted on the y-axis 14 of the graph 10. A curve 16 shown on the graph 10 thus shows the valve stroke and thus the movement of the intake valve out of the closed position into the open position and then back into the closed position again, the closed position of the intake valve being denoted in FIG. 1 by S and the open position of the intake valve being denoted by O.

Within the context of the method shown in FIG. 1 for operating the internal combustion engine, four injections E1, E2, E3 and E4 are performed by means of the injector, a corresponding amount of the fuel being injected directly into the combustion chamber by means of the injector in each case, within the context of the temporally mutually spaced injections E1-4. The amount of fuel in each case is also referred to as the injection amount. It can be seen from FIG. 1 that all the injections E1-4 are performed by means of the full stroke VH of the injector. It can be seen in FIG. 1 that at least two of the full strokes VH, and thus the injections E1-4 which are part of these two full strokes, differ from one another in their respective injection times, as a result of which different injection amounts are injected directly into the cylinder within the context of these at least two full strokes VH.

For example, the number of strokes of the injector performed within precisely one intake stroke of the internal combustion engine is within a range of 2 to 8, inclusive. In the method shown by FIG. 1, precisely 4 full strokes VH are performed within the operating cycle and thus 4 temporally mutually spaced injections E1-4 are performed.

It can be seen from FIG. 1 that the full stroke VH that causes the injection E2 is performed at least in part, in particular at least mostly, while the intake valve is open. In the present case, the full stroke VH that causes the injection E1 and the injection E2 is performed while the intake valve is open. The full stroke VH that causes the injection E3 is also performed at least in part, in particular at least mostly or in full, while the intake valve is open.

In order to achieve an especially favorable operation of the internal combustion engine in terms of consumption and emissions, in each of the embodiments of the method shown by FIG. 2 to 4, the fuel is injected directly into the cylinder by at least one partial stroke TH of the injector being performed while the intake valve is open. FIG. 2 illustrates a first embodiment of the method. In the first embodiment, the respective partial strokes TH that cause the injections E1 and E2 are performed in full while the intake valve is open. Moreover, the partial stroke TH that causes the injection E3 is performed in part, in particular at least mostly, while the intake valve is open. Also in the first embodiment, precisely four injections E1-4 are provided during or within the operating cycle, all of the injections E1-4 being caused by respective partial strokes TH of the injector. Since the four injections E1-4 are provided, a 4-fold injection is provided.

FIG. 3 shows a second embodiment of the method. In the second embodiment, the injections E1 and E4 are each caused by the full stroke VH of the injector. The injections E2 and E3, however, are each caused by a partial stroke TH of the injector. In total precisely four injections are also provided in the second embodiment, the full stroke VH that causes the injection E1 and the partial stroke TH that causes the injection E2 each being performed in full while the intake valve is open. A first portion of the partial stroke TH that causes the injection E3 is performed while the intake valve is open, and a second portion thereof is performed while the intake valve is closed. In the second embodiment, the full stroke VH that causes the injection E4 is performed in full while the intake valve is closed again. Analogously thereto, in the first embodiment the partial stroke TH that causes the injection E4 is performed in full while the intake valve is closed again. In the second embodiment, a 4-fold injection is thus provided as a combination of two full strokes VH together with two partial strokes TH.

FIG. 4 lastly shows a third embodiment of the method, in which five injections E1-5 and thus a 5-fold injection are provided. The injections E1 and E2 are caused by a corresponding full stroke VH of the injector, the injections E3-5 each being caused by a partial stroke TH of the injector. In this case, the full strokes VH that cause the injections E1 and E2 and the partial strokes TH that cause the injections E3 and E4 are performed in full while the intake valve is open. Moreover, the partial stroke TH that causes the injection E5 is performed in full while the intake valve is closed again.

It can be seen from FIG. 2 that the injection time of the partial stroke TH that causes the injection E1 is shorter than the injection time of the remaining partial strokes TH. In the second embodiment, the partial strokes TH each have longer injection times than the full strokes VH, the full stroke VH that causes the injection E4 having a longer injection time than the full stroke VH that causes the injection E1. Moreover, the partial stroke TH that causes the injection E3 has a longer injection time than the partial stroke TH that causes the injection E2.

In the third embodiment, the partial strokes TH have the same injection time, the injection time of the full stroke VH that causes the injection E2 being shorter than the injection time of the full stroke VH that causes the injection E1. The fact that injection E2 temporally follows injection E1, injection E3 temporally follows injection E2 and injection E1, and injection E4 temporally follows injection E3, injection E2 and injection E1, applies to all embodiments. Furthermore, injection E5 temporally follows injection E4, injection E3, injection E2 and injection E1. Moreover, the respective injections E1-5 are temporally mutually spaced and are thus designed as individual injections. The 5-fold injection provided in the third embodiment is shown as a combination of two full strokes VH together with three partial strokes TH.

Due to the fact that at least one partial stroke TH for injecting fuel is performed while the intake valve is open, the raw emissions, and in particular the particle emissions, and the fuel consumption of the internal combustion engine can be kept particularly low, since wetting of the intake valve, the cylinder wall, the combustion chamber roof and the piston with fuel can be kept particularly low. In this case it is preferable for the method to be carried out during a warm-up period for heating up the internal combustion engine, it also being possible, however, to carry out the method when the internal combustion engine is already hot.

1.-9. (canceled)

10. A method for operating an internal combustion engine, wherein the internal combustion engine comprises a combustion chamber, an intake valve associated with the combustion chamber, and an injector associated with the combustion chamber, comprising the steps of:
injecting fuel directly into the combustion chamber by strokes of the injector during precisely one inlet stroke of the internal combustion engine and during a warm-up period for heating up the internal combustion engine, wherein a number of the strokes is four or five, wherein the strokes include a first partial stroke while the intake valve is open, and wherein at least one of the strokes is performed while the intake valve is closed.

11. The method according to claim 10, wherein the strokes include a second partial stroke.

12. The method according to claim 10, wherein each of the strokes is a partial stroke.

13. The method according to claim 10, wherein at least one of the strokes is a full stroke.

14. The method according to claim 10, wherein at least two of the strokes differ from one another with regard to a respective injection time.

15. An internal combustion engine which performs the method according to claim 10.
